(19) United States
(12) Patent Application Publication
(10) Pub. No.: US 2006/0115328 A1
(43) Pub. Date: Jun. 1, 2006

(54) System for draining and irrigating athletic fields

(76) Inventor: William H. Smyers JR., Wethersfield, CT (US)

Correspondence Address: TED PAULDING, 10 PENWOOD LA., WETHERSFIELD, CT, 06109, US

(21) Appl. No.: 10/998,319

(22) Filed: Nov. 26, 2004

(51) Int. Cl. A01G 25/00

(52) U.S. Cl. 405/50

(57) ABSTRACT

A water control system is described for providing drainage and/or irrigation of an athletic field or other surface without using thick beds of sand and gravel, and without removing existing turf or buying new turf. A lower layer of the system is a series of typically parallel, generally horizontal trenches, widely spaced and containing coarse gravel and optional perforated pipes on a gentle slope. The downstream ends of the trenches join with a collector which drains water away from the site. An upper layer of the system comprises another set of usually narrower, shallower, and more closely spaced parallel and upwardly open slots filled with finer porous media such as sand, and intersecting the trenches at an angle such as ninety (90) degrees. Porous tubing may be used at a slight slope along the bottom of these slots to conduct water to openings in the tubing at the intersections. A thin layer of porous media, often mixed with other materials such as compost or peat, is spread on top and raked such that grass can grow through it. This layer conducts water horizontally to the nearest slot in order to drain surface water rapidly even if the original turf has very low permeability. During dry seasons a water level can be maintained in the collector and hence in the media of the slots for irrigation, thus eliminating the need for a sprinkler system. During rainy seasons, the collector may be left open for rapid drainage.

### BACKGROUND OF INVENTION

Irritation

Many approaches have been used for both irrigating and draining surfaces such as athletic fields. Irrigation systems typically comprise a network of underground piping connected to retractable sprinkler heads. Such a system has many disadvantages:
1. The safety of players can be jeopardized in case heads are not installed deep enough or if they occasionally don't fully retract and a player falls knee-first on to a sprinkler. A ball hitting the location of a sprinkler head may bounce at an unexpected angle, or a player's foot may twist when planting his foot at a sprinkler location. A leaky sprinkler may result in a hazardous muddy soft spot in the field
2. There are problems of obtaining uniform coverage since the heads typically give circular patterns or sectors thereof, so that there are inevitably either some areas that don't get enough water or some that get too much from overlapping patterns.
3. Water is lost to evaporation in the air before it even gets to the grass.
4. The system requires substantial water pressure in order to spray a significant distance from the heads, so the needed strength of the piping increases the cost.
5. The system also requires a substantial flow rate because the watering must be accomplished during periods of field disuse, allowing for time for the grass to dry before games or other field maintenance. Often the watering is limited to a few pre-dawn hours, and the large flows require large pipes, thus further increasing system cost.
6. There is a continuing maintenance cost of figuring on a daily or weekly basis in response to weather, how much water to apply to avoid over or under watering.

To ameliorate these disadvantages, others such as Daniel U.S. Pat. Nos. 3,908,385, & 5,590,980, Motz U.S. Pat. No. 5,752,784, and Bonhoff U.S. Pat. No. 5,848,856 have used underground drainage systems to also provide irrigation. Such dual use is no longer novel, but remains a desirable feature of the invention I will describe.

Drainage

Many different drainage systems have also been used for athletic fields. Generally the approach is to configure one or more thick layers of porous material such as sand and/or gravel beneath the turf, with progressively coarser, more permeable layers at the deeper levels. The total thickness of the beds of material may total several feet. Sometimes the system is created on top of an existing field, so that all the material for the permeable layers and new top soil must be purchased, trucked to the site, and placed. In other cases at least the existing top soil may be scraped off and saved, with possibly more excavation to make space for permeable layers depending on how much total buildup is desired or tolerated. The cost of buying and applying either top soil or thick layers of sand and gravel is substantial, and the systems also have other disadvantages:
1. In many cases the existing top soil itself, has such low permeability that no matter how well drained the lower layers are, the turf will still stay muddy for an extended time after a storm. Buying new top soil for turf, and ensuring that all truck loads have at least a minimum permeability, may be difficult and expensive.
2. Often the field may have to be “crowned” so that surface water will run off, obviously an undesirable feature where rolling balls are involved.

Piping systems are frequently used in or below the porous media layer to speed the horizontal movement of water off site, or to intermediate collection points. Various configurations have been used with many combinations of perforated and solid pipes at different levels with and without trenches.

Some of the previous efforts to improve the performance of drainage systems include:

Daniel U.S. Pat. No. 3,908,385—uses a grid of trenches with imperforate pipes in deeper trenches coupled to perforate laterals in upper trenches with a thick bed of sand above the trenches. The upper few inches of the sand layer are mixed with peat and other materials to form a rooting medium for the turf. Vacuum is applied to drain, and pressure to irrigate.

Robey U.S. Pat. No. 4,023,506—uses a grid of pipes, apparently coupled in a single depth set of perpendicular trenches with a thick bed of sand above.

Daniel U.S. Pat. No. 5,590,980—uses a 3 layer grid, with imperforate horizontal pipes in trenches at the lowest level, coupled to a perpendicular set of imperforate horizontal pipes above, which in turn are coupled to a set of parallel (to the bottom trenches) perforate pipes in the top level. The top 2 levels are in a single, deep bed of sand with a rooting medium in the top 2 inches. Irrigation is provided, and vacuum is used to assist drainage.

Motz U.S. Pat. No. 5,752,784—has a grid with lower pipes in trenches and perpendicular upper ones with flattened, perforate pipes, coupled to, and intersecting with the upper half of the lower pipes. The minimal resulting decrease in sand bed thickness from a previously required 14 inches, to his resulting 12 inches was expected to yield a saving of $25,000 for the field.

As will be apparent, the major costs of drainage systems are the thick beds of porous material and/or any special piping material and labor required. However, all previous work seems to continue the use thick beds of sand/gravel, and if a grid of pipes is used, either a special coupling or a labor-intensive hook-up of standard fittings is included. Naturally any auxiliary system, such as a source of vacuum, is also a major cost.

### SUMMARY OF THE INVENTION

To ameliorate the problems and costs described, I have invented a novel design of a drainage and/or irrigation system for athletic fields and the like. Naturally the system can also be used for any other application such as lawns, agricultural fields, golf courses etc. where similar requirements exist, or even for a surface such as artificial turf where only the drainage requirement is present. The purpose of the invention is to:
1. eliminate the wholesale excavation in favor of a grid of narrow slots and trenches.
2. eliminate the purchase and placement of thick beds of porous material or new top soil in favor of one thin layer of porous material on top of existing ground, and minor amounts for filling slots and trenches.
3. achieve rapid drainage while retaining the original turf in place, even though the top soil has unacceptably low permeability.
4. eliminate the cost of plumbing connections between upper slots and lower trenches by using properly sized porous media at the intersections and perforated pipes in the lower trenches.
5. eliminate the need for “crowning” the field, thus permitting a flat, level playing surface.
6. completely eliminate any sprinkler system, and all attendant problems of uniform spray coverage, leakage, expensive piping, safety hazards, watering schedules, and waste of water.
7. allow the turf to absorb whatever water it needs, in response to daily variations in humidity, rainfall, sun, wind etc., rather than trying to estimate these needs and sprinkle accordingly.
8. achieve the goal of item 7. by simply maintaining a fixed subterranean water level in the media of the slots during dry periods, using only low flow, low pressure water supplied to a collector up to 24 hr. per day.
9. achieve a system which can be used for either irrigation or drainage independently, or both as the need develops.
10. achieve the drainage function with natural gravity flow without the use of an auxiliary vacuum system.

### DESCRIPTION OF THE DRAWINGS

FIG. 1 is a plan view of an athletic field with my draining and irrigating system shown in broken line form,

FIG. 2 is an enlarged fragmentary plan view showing a portion of my system,

FIG. 3 is a cross section of the FIG. 2 portion of the field with the vertical dimensions enlarged,

FIG. 4 is a further enlarged fragmentary cross sectional view of an intersection between a slot and a trench, and

FIG. 5 is a cross sectional view taken at right angles with respect to FIG. 4.

### DESCRIPTION OF PREFERRED EMBODIMENT

The following description of a typical system for a 390 by 240 ft. soccer field uses exemplary dimensions so that a typical configuration can be readily visualized. Naturally those skilled in the art can vary these numbers over wide ranges depending upon the application, while still making use of the primary features of the invention.

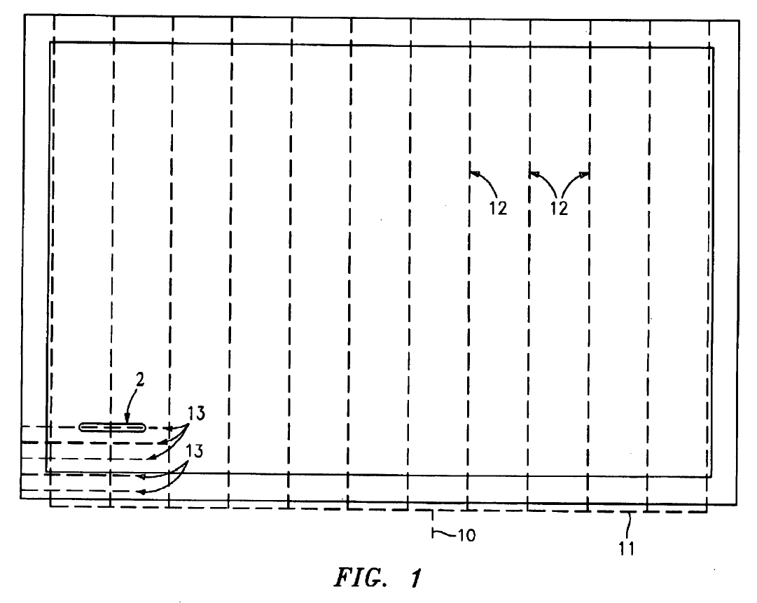

FIG. 1 shows an exit 10, typically a pipe or ditch, to conduct drainage water off site. It receives discharge from collector 11, also typically a pipe or ditch. Collector 11 receives discharge in turn from 12 horizontal trenches 12 in a lower layer. The trenches are 240 ft. long and spaced 32.5 ft. apart, 3 of which are labeled as examples. There are 30 horizontal slots 13 in an upper layer, only 5 of which are partially shown and labeled to avoid clutter in the figure. The slots are 390 ft. long, and are spaced 8 ft. apart. They intersect the trenches at an angle, in this case 90 degrees, and water can drain from the slots into the trenches. It will be understood that the layout can be varied widely depending upon the application, such as making all the trenches emanate from one location as radial lines and letting the slots be arcs of circles, or having just one trench on a winding path with many shorter slots crossing it in a configuration that looks like the depiction of a railroad on a map. The collector might run down the center of a field with all trenches draining centrally toward it, or there might be 2 or more collectors off the field with trenches draining from the center outwardly. Unequal spacing of slots or trenches and varying intersection angles may be used for some purposes.

FIG. 2 shows short enlarged sections of a trench 12 and a slot 13. The dashed lines denote the 32.5 by 8 ft. area (labeled 2 in FIG. 1) that will typically be drained to intersection 14. That is, surface flow goes toward slot 13, and then within slot 13, flows toward intersection 14 as shown by the small un-numbered arrows.

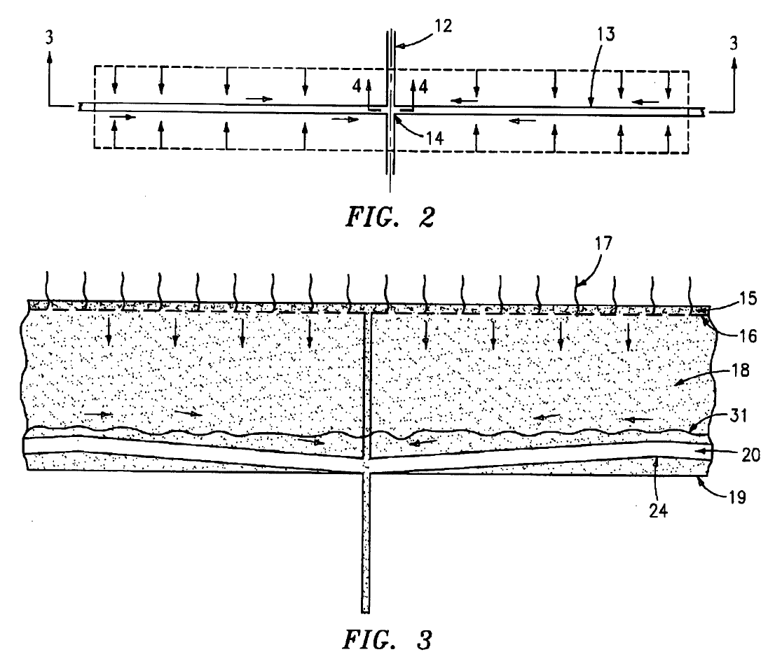

FIG. 3 illustrates a thin layer of porous media 15 on top of the original ground line 16. In this example, the media 15 is a 1 in. thick mixture of coarse sand (e.g. size 0.05 to 0.01 in.), with small fractions of compost and soil. The primary purpose of media 15 is to create a high permeability path for water to flow horizontally to the slots so that the field can drain even though the original soil below ground line 16 has low permeability. The small amounts of other materials such as soil or compost add some stability to the layer and should be in small enough fractions that the mixture still has good permeability, 50 in./hr. in this case.

“Permeability” as used herein refers to true, vertical, one-dimensional permeability. That is, the media being tested is packed into a vertical pipe, but retained by a suitable screen at the bottom of the pipe. A very thin layer of fluid is maintained on the top of the media, and the steady-state flow rate from the screened end is measured, and converted to in./hr. using the inside cross sectional area of the pipe. This measure of permeability is different from that of field tests where water can seep sideways in the ground during the test.

Grass 17 is shown as growing up from original ground line 16. Typically the grass is established before the media 15 is added, and is raked to lift the tops of the grass leaves up through media 15. The procedure may be accomplished in steps using more than one extra thin layer of media 15. The slot 13 is filled with a second porous media 18 such as coarse sand, in this example having a permeability of 100 in./hr. or more. The purpose of the second porous media 18 is to permit the flow which has reached the top of the slots, to flow downward as shown by the un-numbered vertical arrows and thence toward trench 12 as shown by the similar horizontal arrows in FIG. 3. In the example shown, the slot depth is about 8 inches as denoted by the bottom 19 of the slot. The slot is about 1 in. wide, and in this example porous tubing 20 is laid in the bottom of the slots at ½ percent slope to further facilitate the flow toward trench 12. The cross section of trench 12 is distorted in FIG. 3 by the expanded vertical scale, and is discussed more clearly in relation to the next Figure.

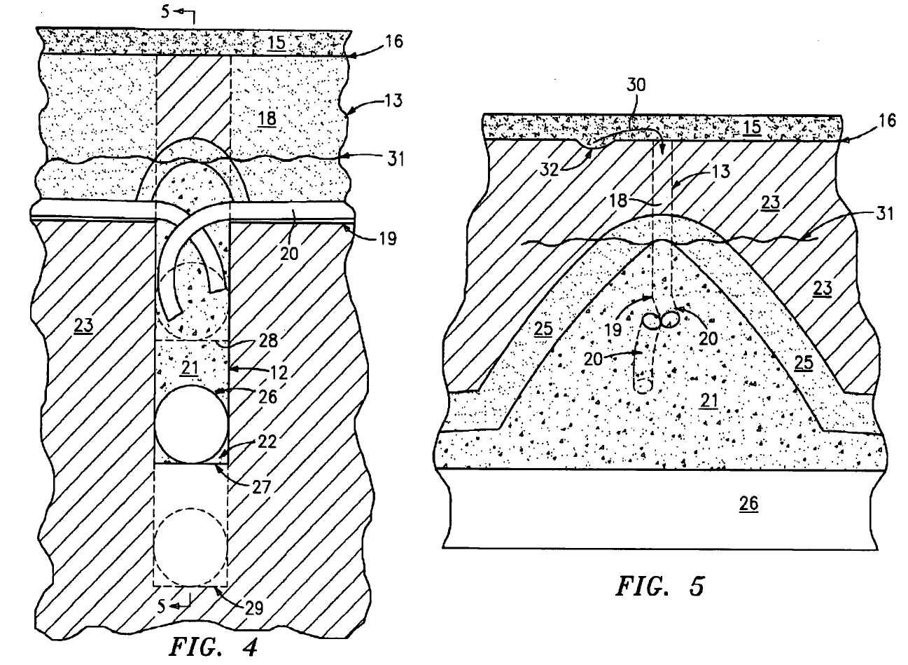

In FIG. 4 horizontal and vertical scales are identical to be in true proportion. The cross section is a lengthwise slice down the center of slot 13 at a point about half way along the length of trench 12. At this point the bottom 27 of the trench is about 20 inches deep from the original ground level 16. The relative elevations of the upstream end 28, and the downstream end 29, are shown as dashed lines reflecting the 0.4% slope of the trench 12. In this application perforated pipe 26 rests on a small bed of sand in the bottom of trench 12, and is covered along most of its length with a few inches of coarse media 21 such as pea gravel. The entire trench 12 can be filled with pea gravel, leaving only about a 6 inch depth unfilled, but pea gravel for this application is much more expensive than sand or soil, so only a few inches of it are used over most of the length of the pipe 26.

FIG. 5 shows that to minimize the use of expensive pea gravel, the gravel is only piled up in the trench at each intersection 14 of the trench 12 with a slot 13. If the porous tubing 20 is flexible enough, it can simply be bent down into the trench; otherwise a short elbow can be inserted into the tubing to deflect the outlet flows from the tubing downward into the trench. The pea gravel is added after the tubing ends have been positioned. Any place pea gravel is used, generally at least a thin layer of sand 25 is placed above it as shown in FIG. 5 to minimize migration of soil above into the pea gravel. Most of the original soil 23 that has been removed to create the trench can be replaced as shown in FIG. 5. This replacement is desirable because the trenches are generally wider than the slots, and having firmer turf rooted in soil provides better footing for players than would a deep sand base. The slots, on the other hand, are considerably narrower than a player's shoe, and do not pose a significant hazard when filled with sand up to the original ground level 16.

A typical water level 31 might be maintained in the system for irrigation purposes, generally at some level between the bottom of the slot and the root level of the turf. It is desirable that the sand 18 in the slots be fine enough that it will wick up water from that level to the top layer 15, but not be so fine that it will restrict the downward flow in the slots (or the horizontal flow in the slots if tubing is not used).

For any particular application the designer must make sure that the flow capacity of each portion of the drainage path is adequate for the design rainfall rate. Horizontal flow capacity through media 15 to the slots 13, vertical and then horizontal flow in the slots 13 to the trenches 12, flow through the connection between the slots and trenches, then vertical and horizontal flow in the trenches 12, to the collector 11, and flow through the collector 11 and exit 10 must each be large enough to avoid being an undue restriction to the whole flow path. Those skilled in the art of flow through passages and porous media will readily find a combination of dimensions that yield a much lower cost burden using this system than one using complete beds of sand and gravel beneath the turf and connected piping systems. It is particularly useful in this system to note that since flow is continually added along the length of the passage, the horizontal flow in both the slots and trenches is not constant along the length, but varies from zero at the upstream end, (position 24 for a slot), to its nominal value at the downstream end. Though not used in the sample system, a section of larger pipe in the last ⅕ or so of a passage length, may be all that is needed to meet some low available head limitation, or some extra coarse media at the bottom of the slot or trench might be sufficient for the upstream three fourths of the passage, with tubing or piping only at the downstream end.

There may be cases where exit 10 and collector 11 are not needed, for example, if the whole field is slightly elevated, and the trenches can drain to open lower ground. There may even be similar cases where no trenches are used and the surface layer 15 and slots 13 can drain to open ground, or where the existing turf has high enough permeability that it can substitute in function for layer 15.

It will be noted that the surface media 15 has a capillary action property, and that in the drainage mode, excess water which might otherwise tend to collect in a local depression 32 in the original top surface 16, will be siphoned up, over, and down into slot 13 as shown by arrow 30 in FIG. 5 so long as water level 31 is lower than the depression 32. The media 15 may stay damp, but excess water will be drained.

In the irrigation mode exit 10 is blocked up to some over flow level, and a low pressure, low flow source of water is supplied to collector 11, and maintained in collector 11 at approximately level 31, FIG. 5, by any well-known means, for instance the float valve on a toilet tank. The over flow level at exit 10 will normally be an inch or so above level 31. The reverse flow needed for irrigation will generally be much smaller than the normal flow required for drainage. For instance, grass will generally grow very well with a rainfall of 1 inch per week, while even a modest drainage system might be required to handle storms of up to 1 in/hr., or 168 times the flow rate. There will therefore generally be negligible pressure loss due to irrigation flow in the system, and level 31 at the collector will be essentially the same as level 31 in the slots. That level will generally be set somewhere between the bottom 19 of the slots, and the bottom of the turf roots which may be 3 or 4 inches below the ground level 16. In the example shown, the water level 31 is set 5 inches below original ground level 16. Water can reach the roots of the turf by slowly seeping horizontally away from the slot through the soil below water level 31, and thence upward by capillary action in the soil, to the roots. It will be noted that a simple method of fertilizing the field is to merely add a soluble fertilizer to the water in the collector. Second porous media 18 should be fine enough that capillary action will also draw water from level 31 up to the top of media 15, so that horizontal seepage for complete irrigation coverage can also occur above water level 31, through media 15 at a much more rapid rate than can be achieved by low permeability soil. Sand with a spread of particle sizes in the 0.05 to 0.01 inch range has good capillary action yet also reasonably high permeability for drainage flow.

For typical use the system may be left in the irrigation mode at all times. The grass will take up what ever water it needs regardless of variations in sun, wind, temperature, humidity etc. For light rain occurring during the irrigation mode, the water might rise an inch or so above level 31 to overflow the blockage at exit 10, and the field will drain but slowly since only about 5 inches of head drives the flow. Before, during, or immediately after a heavy rain, exit 10 can be unblocked to permit rapid draining under the full head of about 24 inches or more.

The procedure for building the sample field and system is considerably less costly than that for conventional systems:
1. Level the field. For irrigation within about ±2 inches in the example to ensure that the nominal 5 inch deep water level 31 will be above the bottom of the slots 13 yet not flood the turf. Optionally plant more grass on disturbed areas.
2. Run 4+ inch trencher along the trench 12 lines, adjusting for grade if desired for pipe. Make sure that highest top of pipe will be well below expected bottom of slot level 19 to avoid damage when cutting slots.
3. If pipe is to be used, lay thin bed of support sand then the pipe 26 on grade, then add several inches of coarse media 21 all along on top of the pipe.
4. Run 1+ inch trencher along all slot 13 lines.
5. Optionally form bed for porous tubing on slope, and lay about 34 ft. lengths of tubing in slots 13, bending the outlet ends of the tubing down into the trenches at each intersection with a trench.
6. At each slot intersection, pile up coarse media 21 in the trenches to a few inches above the bottom of the intersecting slot.
7. Add a few inches of sand above the coarse media along the entire length of the trench.
8. Fill the rest of the trench to original ground level (or mounded a little higher to allow for settling), using most of the soil that was excavated during trenching.
9. Fill slots to ground level with second porous media 18, mounding or packing as required.
10. Remove excess, or re-spread left-over soil from slotting & trenching to restore a level surface.
11. Spread porous media 15 over top surface then brush or rake to bring up turf leaves to surface and to mix various components of media 15.

1. In a water control system for athletic fields and the like, the combination of a thin layer of high permeability porous surface media placed directly on the original horizontal surface of the field to enhance the horizontal flow of surface water and to provide a capillary action for the flow of water away from depressions, a lower horizontal water transfer layer comprising at least one substantially horizontally extending trench at least partially filled with porous media in its lower portion, an upper vertical and horizontal water transfer layer above the lower transfer layer comprising a series of spaced apart substantially horizontally extending narrow generally vertical slots each at least partially filled with porous media and communicating downwardly with the porous media in said at least one trench for the vertical downward flow of water from said surface media through and then along the slots horizontally to the trench, and means receiving water from at least one trench and conducting water away from the field.

2. In a water control system for athletic fields and the like, the combination of a thin layer of high permeability porous surface media placed directly on the original horizontal surface of the field to enhance the horizontal flow of surface water and to provide a capillary action for the flow of water away from depressions, a lower horizontal water transfer layer comprising at least one substantially horizontally extending trench at least partially filled with porous media in its lower portion and filled there above with material at least similar to the material on site to the original horizontal surface of the field, an upper vertical and horizontal water transfer layer above the lower transfer layer comprising a series of spaced apart substantially horizontally extending narrow generally vertical slots each at least partially filled with porous media and communicating downwardly with the porous media in said at least one trench for the vertical downward flow of water from said surface media through and then along the slots horizontally to the trench, and means receiving water from at least one trench and conducting water away from the field.

3. A water control system as set forth in claim 1 wherein the layer of porous media comprises a mixture of porous sand and small amounts of additives such as compost and soil, and where the existing turf is raked or brushed so that the leaves project upwardly through the layer.

4. A water control system as set forth in claim 1 wherein the slots are spaced at least 4 and less than twelve feet apart.

5. A water control system as set forth in claim 4 wherein the slots are spaced approximately eight feet apart and are approximately one inch wide.

6. A water control system as set forth in claim 1 wherein there are a plurality of trenches arranged in series and spaced at least fifteen and less than forty-five feet apart.

7. A water control system as set forth in claim 6 wherein the trenches are approximately thirty-two and one half feet apart.

8. A water control system as set forth in claim 1 wherein said at least one trench is filled to a level above the bottom of the slots at intersections with the slots.

9. A water control system as set forth in claim 1 wherein the layer of media on the original surface is between one half and two inches thick.

10. A water control system as set for the in claim 9 wherein the layer for media is approximately on inch thick and comprises coarse sand (in the range of 0.01 to 0.05 in.)

11. A water control system as set forth in claim 1 wherein the slots are filled with a porous media such as coarse sand having a permeability of 100 in./hr. or more.

12. A water control system as set forth in claim 1 wherein said water receiving means has associated valve means operable to maintain a water level in the slots of the system slightly below the turf roots adjacent thereto.

13. A water control system as set forth in claim 1 wherein perforate pipes are provided in lower portions of the trenches.

14. A water control system as set forth in claim 1 wherein perforate tubes are provided in lower portions of the slots.

15. A water control system as set forth in claim 14 wherein there are a series of spaced apart trenches and wherein the pipes are sectioned to coincide with the spacing of the trenches with their end portions disposed at intersections with trenches and directed downwardly to enhance the discharge of water there from into the porous media in the trenches.

16. A water control system as set forth in claim 15 wherein perforate pipes are provided in lower portions of the trenches.

17. In a water control system for a field, one or more trenches at least partially filled with porous media, multiple slots above and intersecting the trenches at an angle and at least partially filled with porous media, the media of the trenches being filled to a level above the bottom of the slots at the intersections of the slots and trenches thereby providing a fluid connection from the slots to the trenches, means to conduct surface water falling on the surface of the field to the slots, means to conduct water away from the trenches as necessary.

18. In a water control system for a field, a thin layer of high permeability porous media laid directly on top of the original surface of the field such that incident water can drain horizontally from the field through this layer to slots at least partly filled with porous media, means to collect the water at one or more points along each slot, and means to conduct the collected water away from the field as necessary.

19. Claim 17 wherein the lower portions of the trenches also contain perforated pipes to more readily pass the water along the trench.

20. Claim 17 wherein the lower portions of the slots also have porous tubing to more readily conduct water along the slots.

21. Claim 20 wherein the downstream ends of the porous tubing also deflect the flow downward into the porous media of the trenches.

22. Claim 18 wherein the lower portions of the slots also have porous tubing to more readily conduct water along the slots.

23. Claim 18 wherein the layer of porous media on the surface is a mixture of coarse sand with small fractions of additives such as compost and/or soil, and where the existing grass is raked up or brushed so that the leaves project up through the layer.
